(19) United States
(12) Patent Application Publication
(10) Pub. No.: US 2013/0008096 A1
(43) Pub. Date: Jan. 10, 2013

(54) UTILITY POLE

(76) Inventors: Michael Griffiths, Caringbah (AU); John Michael Jarvie, Cronulla (AU)

(21) Appl. No.: 13/636,647

(22) PCT Filed: Apr. 1, 2010
(86) PCT No.: PCT/AU10/00377

§ 371 Date: Sep. 21, 2012

(51) Int. Cl. H02G 7/00; E02D 27/42; E01F 9/018; H01B 17/14; E04H 12/24

(52) U.S. Cl. 52/99; 52/831; 52/651.02; 52/309.4; 52/169.13

(57) ABSTRACT

A utility pole comprises a hollow elongate body (1) formed from a composite material including reinforcing fibres embedded in a matrix material and an energy-absorbing region comprising at least one elongate weakened zone (2, 4, 12) formed in the hollow elongate body (1), the at least one weakened zone promoting delamination of the fibres and the matrix material if a vehicle strikes the utility pole.

### FIELD OF THE INVENTION

The present invention relates to utility poles, and in particular to utility poles with enhanced safety features.

### BACKGROUND OF THE INVENTION

Utility poles, which are traditionally made of timber, metal or concrete, support signs, traffic signals, lighting systems or the like and are often located close to roadways. An impact of a vehicle with a utility pole can result in serious damage to the vehicle, and can also result in injury to the occupants of the impacting vehicle.

Mostly, such roadside poles are left exposed to impacts with vehicles, however when poles are particularly badly located with respect to likelihood of vehicles striking them, a common practice is to use a guardrail so as to direct a vehicle around the pole. There are, however, currently perceived to be too many roadside poles for this to be a practical economical solution.

One possible solution is to design poles that break away from the base during heavy impact from a vehicle. Some of the drawbacks of this approach are that after breaking away, the heavy poles can fall back onto the vehicle, potentially causing serious injury to the vehicle occupants, or can gain energy from the vehicle impact and be thrown forward so as to potentially cause significant injury to other road users.

Another potential problem is that where the utility pole is supporting electricity cables, the cables can break and fall onto the impacting vehicle, the roadway or other road users. Cables carrying high voltage electricity can represent a considerable danger to road users.

Any discussion in the present specification of documents, publications, acts, devices, materials and the like is included for the purpose of providing a context for the present invention and is not an admission that the subject matter of the discussion forms part of the prior art base, or is part of the common general knowledge in Australia or any other jurisdiction.

### SUMMARY OF THE INVENTION

According to a first aspect of the invention there is provided a utility pole comprising:
a hollow elongate body formed from a composite material including reinforcing fibres embedded in a matrix material; and
an energy-absorbing region comprising at least one weakened zone formed in the hollow elongate body, the at least one weakened zone promoting delamination of the fibres and the matrix material if a vehicle strikes the utility pole.

The weakened zone may comprise a series of slots through the hollow body.

The series of slots may comprise a first slot at an operatively lower end of the energy-absorbing region and a plurality of second slots that are co-linear with the first slot, wherein the second slots are shorter than the first slot.

The first slot may have a length of around 60 cm, the second slots have a length of around 10 cm, and the first and second slots may have a width of around 0.6-0.8 cm.

The weakened zone may comprise a notch in the hollow body extending along the energy-absorbing region.

The utility pole may comprise a first weakened zone and a second weakened zone located diametrically opposite the first weakened zone and wherein in use the utility pole is positioned such that an axis joining the first and second weakened zones is approximately ninety degrees to a design direction of impact of the vehicle.

The utility pole may comprise a base region that in use is mounted in the ground or other supporting medium, wherein the energy-absorbing region is provided above the base region such that in use the energy-absorbing region is above the ground or supporting medium.

The utility pole may comprise compressible material provided within the hollow body in at least the energy-absorbing region and a plunger located within the hollow body above the compressible material with a link connecting the plunger to a base of the pole wherein, if the link is laterally displaced during a collision of the vehicle and the pole, the link pulls the plunger through the compressible material thereby absorbing energy from the collision and retarding motion of the vehicle.

The compressible material may be a foam.

According to another aspect of the invention there is provided a utility pole assembly comprising:
a hollow elongate body formed from a composite material and having a base region that in use is mounted in the ground or other supporting medium and an energy-absorbing region comprising at least one elongate weakened zone formed in the hollow elongate body, the at least one weakened zone promoting delamination of the composite material if a vehicle strikes the utility pole; and
a top section that in use is positioned above the hollow elongate body to provide a columnar pole assembly.

The top section may have an engaging lower end that fits into an interior of the hollow elongate body.

The top section may comprise a sleeve that fits over an upper portion of the hollow elongate body.

The exterior of the hollow elongate body may have a projecting annular flange to assist in positioning the top section over the elongate body.

The top section may comprise one or more cross arms to support at least one of: power cables, communication cables, light fittings and signs.

The top section may be formed of a material that is lighter than the composite material of the elongate body.

The top section may further comprise:
a sensor to detect at least one of displacement or movement of the top section; and
a signal generator to convey a signal indicative of a collision affecting the pole assembly.

The utility pole assembly may further comprise:
an in-ground sleeve that in use is embedded in the ground or other supporting medium and having an inner volume shaped to accommodate and support the hollow elongate body.

According to another aspect of the invention there is provided a utility pole comprising:

a base section that in use is embedded in a support medium;

an upper portion having a hollow interior;

a shear region between the base section and the upper portion wherein the shear region is configured to shear upon vehicular impact with the utility pole, separating the upper portion and the base section;

an energy-absorbing mechanism positioned in the hollow interior of the upper portion;

a link coupling the energy-absorbing mechanism to the base section;

retarding means positioned in the hollow interior between the coupling mechanism and the base section,

wherein, upon separation of the upper portion from the base section, the link activates the energy-absorbing mechanism, which interacts with the retarding means to limit lateral movement of the upper portion.

As used herein, except where the context requires otherwise, the term “comprise” and variations of the term, such as “comprising”, “comprises” and “comprised”, are not intended to exclude further additives, components, integers or steps.

### BRIEF DESCRIPTION OF THE DRAWINGS

Embodiments of the invention will now be described by way of example only with reference to the accompanying drawings in which:

FIG. 1 shows a side view of a portion of a utility pole having a series of vertically oriented slots;

FIG. 2A shows a portion of a utility pole having a notch formed on an inner wall of the utility pole;

FIG. 2B is a top sectional view of the utility pole of FIG. 2A;

FIG. 3 is a side sectional view of a utility pole with an internal energy-absorbing system including a cable, plunger and compressible foam;

FIG. 4 is a top sectional view of a utility pole including fibres, webbing or cable integrated into the side walls

FIG. 5 shows a side sectional view of a utility pole with a shear region, before break away;

FIG. 6A shows a further side view of the utility pole of FIG. 5;

FIG. 6B shows a top sectional view of the utility pole of FIG. 5;

FIG. 7 shows a side sectional view of the utility pole of FIG. 5 after break away;

FIG. 8A is a sectional end view of a system for connecting a utility pole to a cross arm, the system having an inner sleeve that in use fits into the utility pole;

FIG. 8B is a sectional side view of a system for connecting a utility pole to a cross arm, the system having an outer sleeve that fits over the utility pole;

FIG. 9 illustrates a sleeved base for receiving a utility pole;

FIG. 10 shows an example of an assembly including a pole and a sleeve supporting a cross arm;

FIG. 11A shows a side view of the assembly of FIG. 10;

FIG. 11B is a top sectional view of the pole fitted within the sleeve in the assembly of FIG. 11A;

FIGS. 12A-C show side views of a pole for use in the assembly of FIG. 10;

FIG. 13A shows the assembly of FIG. 10 mounted in a concrete plug embedded in the ground;

FIG. 13B is a top view of the concrete plug of FIG. 13A;

FIG. 13B is a side sectional view of the base of the pole in the concrete plug and having a tie-bar to assist in holding the pole in the sleeve;

FIG. 14 is a schematic representation of the assembly of FIG. 10 after impact and having a delaminated region;

FIG. 15A is a top sectional view of a sleeve having U-channels to accommodate signs or other devices for mounting on the pole assembly;

FIG. 15B is a side view of the sleeve of FIG. 15A; and

FIG. 16 is a photograph from a trial involving a collision of a vehicle with a utility pole and illustrating a region of controlled delamination.

### DETAILED DESCRIPTION OF THE EMBODIMENTS

The utility poles described herein are designed to crush and absorb energy or to break away in a controlled manner when struck by a vehicle. The intended result is to extend the distance over which the impacting vehicle comes to a stop so as to significantly reduce the forces on the vehicle experienced by the occupants. As a consequence this reduces the likelihood of injury resulting from a crash involving the utility pole.

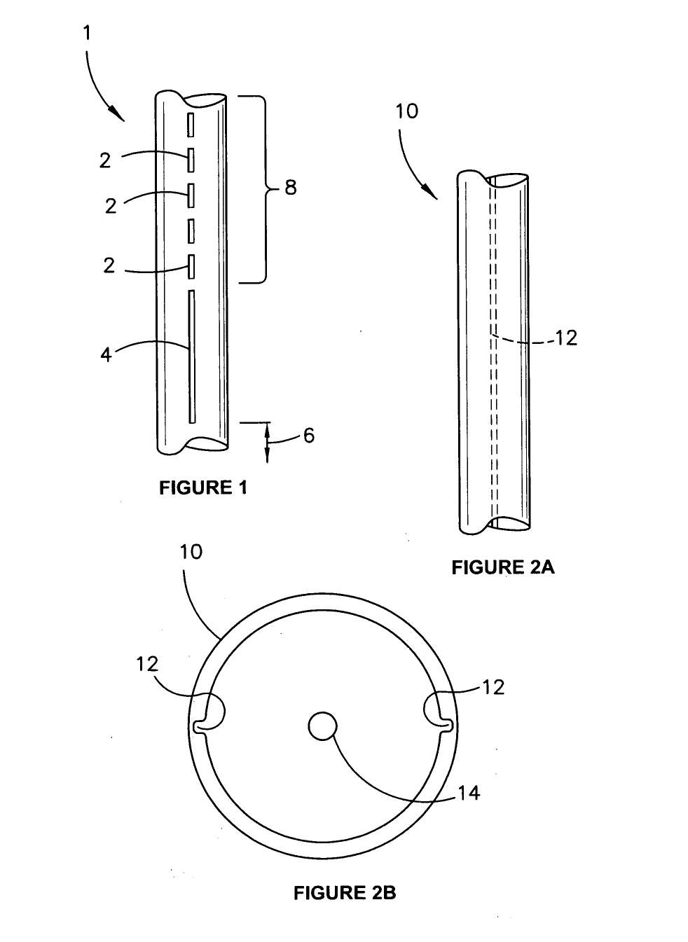

FIG. 1 shows a portion of a utility pole 1 that is manufactured using a composite material. The material provides a pole that is light compared with traditional materials such as wood or metal. The composite material is typically a combination of fibres and a matrix such as a resin, where most of the tensile strength of the composite material is provided by the reinforcing fibres and most of the compressive strength is provided by the solidified matrix. The fibres can be carbon, graphite, Kevlar™, fibreglass or some other suitable fibre that provides the necessary tensile strength for the finished product. Surrounding each fibre strand is a matrix which holds the structure together and allows the product to be formed into various shapes before the matrix material sets. The matrix can be a polymer such as polyester or the like but it could be any other material with suitable properties. Additives may be included in the composite material to provide additional properties. For example, fire-retardant additives may be included.

One example of a suitable composite material for the utility pole of the present invention is Fibre Reinforced Plastic (FRP). Using composite material such as FRP results in a relatively light utility pole, with a weight between 200 and 300 kg for a length of around 10 m.

Production of the utility pole according to the present invention can be done by known manufacturing methods such as the Filament Winding Method, Pultrusion method, moulding and bonding, or any other suitable manufacturing method.

The filament winding method consists of winding continuous rovings of fibre onto a rotating mandrel in predetermined patterns. This method of manufacturing provides control over fibre placement and uniformity of the structure. By adjusting the relative speed or rotation of the mandrel, fibre distribution, and head movement, a helical reinforced pipe is formed.

The pultrusion method is a continuous manufacturing process which creates fibre reinforced polymer profiles of considerable strength and resilience. A reinforcement material is drawn through a liquid thermosetting resin bath. The wet, fibrous laminate is pulled through a heated steel die, where precise temperature control cures the material into the required profile. Necessary strength, colour and other characteristics can be designed into the profile by changes in the resin mixture and reinforcement materials. The fibre reinforcement may, for example, consist of Innegra. The resin or matrix may be a two-component polyurethane-based thermoset resin, for example, Baydur PUL 2500 which bonds the layers of fibreglass reinforcement into a laminate.

The utility pole 1 has a cylindrical outer wall that is formed to have weakened regions, for example a series of continuous or spaced slots. In the arrangement of FIG. 1 the pole has one or more slots 4 through the side wall of the pole, commencing at a distance of about 0.2 m above ground level when the pole 1 is mounted in the ground. The slot 4 is about 0.6 m long and is vertically oriented. In this description “vertical” indicates a direction along the main axis of the utility pole, which is vertical when the pole is installed in the ground.

In region 8 above the slot 4, a series of smaller slots is formed through the side wall. Alternatively, a thinner section of wall may be used instead of the slots 2. In one arrangement the slots 2 are co-linear with slot 4. The slots 2 may be around 6-8 mm wide and 100 mm long with a spacing of 50 mm between slots. Other slot widths, lengths and spacing may be used to fine-tune the control of the delamination process of the pole and the intended energy-absorption capabilities of the pole. For example, a pole located alongside a railway line may require different energy-absorption and yield properties compared to a pole mounted alongside a roadway.

The extent of region 8 may be varied depending on the anticipated masses of impacting vehicles, their probable impact velocity and the distance over which it is intended to absorb the energy of the impact. One design criterion has been to stop a heavy motor car travelling at 100 km/hr over a distance of less than 6 m. For this application slots have been used over a distance of about 6 m above ground level.

The pattern of slots 2, 4 may be repeated at two or more locations around the pole 1. The slots may be located on opposite sides of the pole. The pole may be installed such that an imaginary line joining the two sets of slots is at right angles to the likely direction of approach of an impacting vehicle. The weakened sections provide an energy absorption system by assisting in initiating delamination between the fibres and matrix of the composite pole walls in the event of a collision. The longer slot 4 is thought to assist the start of the delamination and the smaller slots 2 allow for progressive delamination of the utility pole 1.

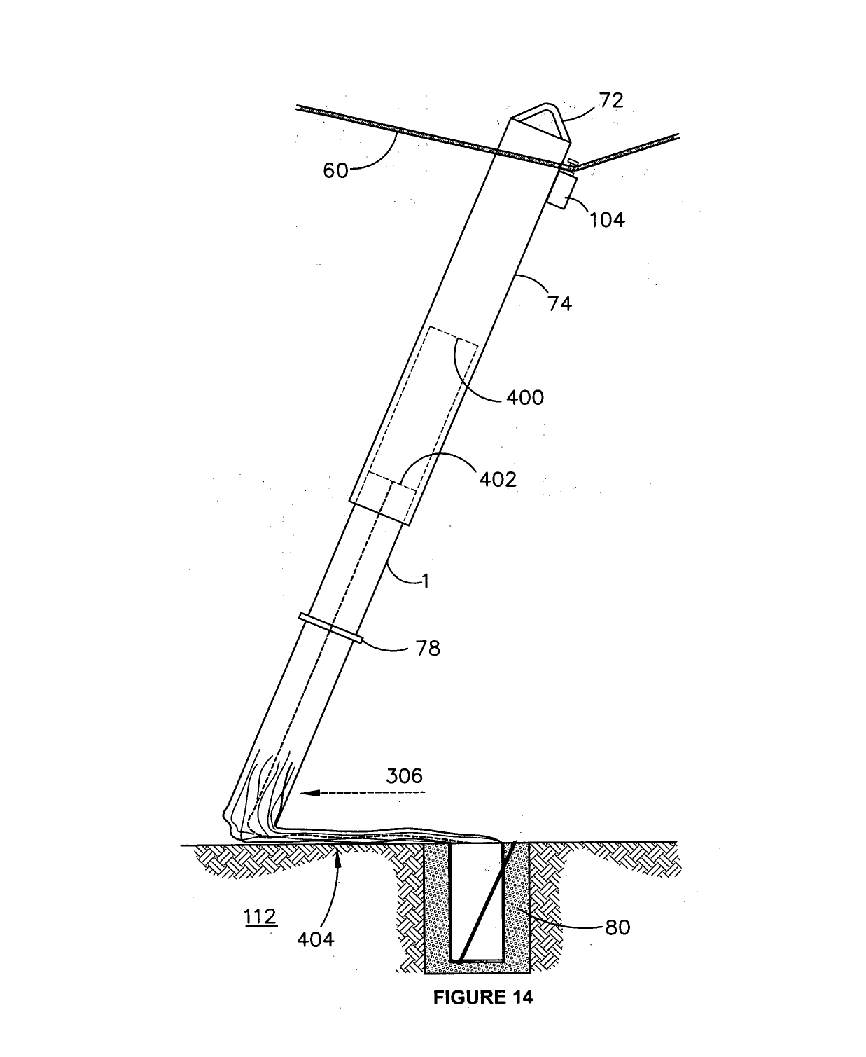

The fibres in the composite material may keep the out-of-ground portion of the pole connected to the base or in-ground portion. The mid-section of the pole is delaminated, crushed and becomes flatter as the impacting vehicle overrides the pole. Portions of the pole may be pushed from a vertical position to a horizontal orientation during impact (see for example FIG. 14).

Depending on the intended application, the cylindrical pole 1 may be filled with a closed-cell or open-cell foam. The foam may be provided with a range of compressibility chosen to assist in the controlled energy absorption during impact. The foam may add stiffness to the pole to counter some weakening associated with the vertical slots or notches. Crushing of the foam during an impact may absorb energy from the collision and thus assist in slowing the vehicle.

Filling the centre of the pole with foam also helps limit infiltration of the interior by water, earth, contaminants or animals.

FIG. 2 shows a further arrangement of a utility pole 10 in which vertical notches 12 provide weakened lines in the walls of the pole. FIG. 2A shows a side view and FIG. 2B shows a top sectional view of an arrangement with two vertical notches 12 formed diametrically opposite one another on interior surfaces of the cylindrical pole 10.

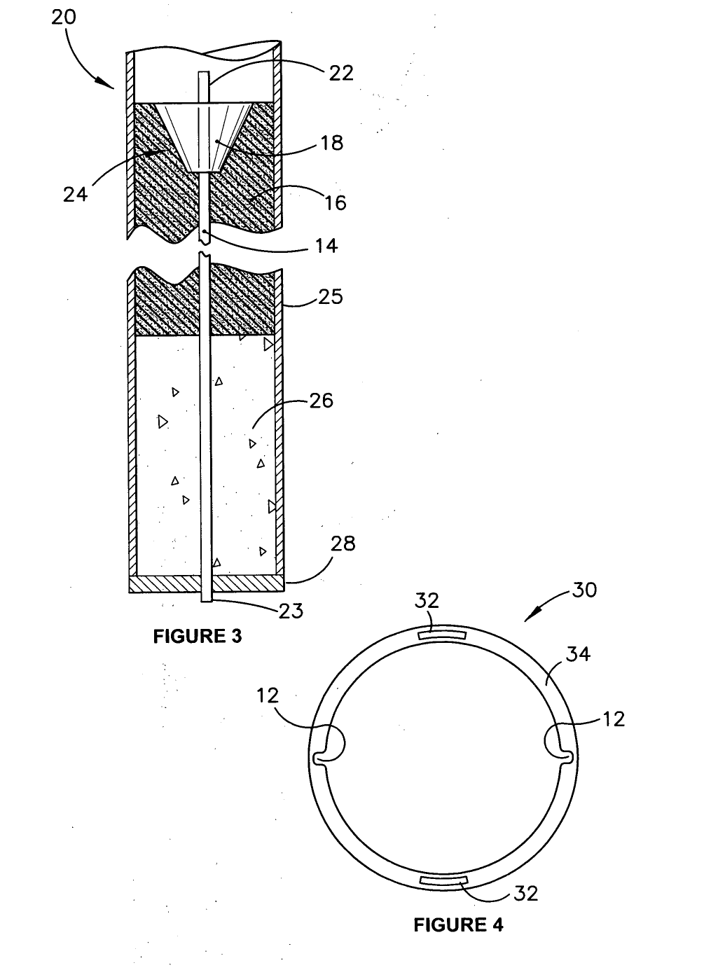

As before, the interior may be filled with a foam. There may be a central cable 14 that is part of a further energy-absorbing system described below with reference to FIG. 3.

The notches 12 provide a weak point that causes controlled delamination of the composite material upon impact. In some arrangements the notches 12 may be provided in combination with the slots 2, 4.

Other ways of providing weak zones in the pole include varying the relative proportions and configuration of the reinforcing fibres and the matrix in the composite material.

FIG. 3 illustrates an arrangement having a further energy-absorbing system positioned in the interior of a utility pole 20. The pole 20 may have slots or notches formed in the composite wall 25 to provide controlled delamination in the event of an impact.

A cable 14 is provided in the interior of the pole 20. At an upper end the cable end is swaged or otherwise mechanically attached to a dye or plunger 18 that has a diameter which decreases in the direction of the base of the pole. As illustrated, the largest diameter of the frusto-conical plunger 18 is less than the diameter of the interior of the pole 20.

The pole 20 has a strong rigid base plate 28. Swaged cable end 23 fixes the cable 14 to the base plate 28. Other attachment mechanisms may also be used to attach the cable to the base plate.

In a region adjacent to the base plate 28, which in use is positioned below ground level, the interior of the pole 20 is filled with a substantially incompressible material 26, which may for example be a foam or concrete. Between the incompressible material 26 and the plunger 18, the interior of the pole 20 is filled with a compressible or crushable foam 16. The height of the plunger 18 generally coincides with the top of the weakened sidewall sections of the pole 20.

Examples of such foams which have been used in testing the poles include Ecofoam GP330, which is a general-purpose rigid polyurethane foam product having a density of around 40 kg/m³ and a compressive strength at 10% of more than 200 kPa; Ecofoam GP450, which is a general-purpose rigid polyurethane foam product having a density of around 50 kg/m³ and a compressive strength at 10% of more than 266 kPa; Erathane GP160, which is a high density rigid polyurethane foam product having a density of around 186 kg/m³ and a compressive stress at 10% of around 2700 kPa; Greenlink HDR400, which is a two-component polyurethane product including polyol and isocyanate mixed to produce a fine-celled foam with a free rise density of 400 kg/m³; Erapol CC60D which is a premium-grade cold-castable polyurethane elastomer. These foams are available from Era Polymers Pty Ltd in Australia.

In some situations, either by design or through an unusual impact, the pole walls of the above-ground part of the pole may separate completely from the below-ground base of the pole. That is, the damage to the walls may extend beyond controlled delamination to a point where all the fibres are severed. In these circumstances a secondary energy-absorbing mechanism comes into play.

An impact to the pole 20 may cause displacement of the lower parts of the pole, in turn pulling the plunger 18 down through the foam 16. In region 24 between the plunger and the pole wall 25 the foam is forced into a decreasing annular volume as the plunger descends. The crushing and compression of the foam 16 absorbs energy. The difference between the largest lateral dimensions of the plunger 18 and the inner cross-sectional area of the pole 20 affects the rate of energy absorption versus the vertical distance travelled by the plunger 18.

Energy absorption may also occur through delamination of the wall 25 caused or accelerated by the outward forces directed from the plunger 18 towards the wall 25.

Another arrangement is illustrated in FIG. 4, which shows a cross-section of a utility. pole 30 having a cylindrical wall 34 formed from composite materials. Two vertical notches 12 are formed in the inner surface of the wall 34 to provide controlled delamination in the event of a collision. In addition there is a stronger tensile reinforcement 32 integrated into the composite wall 34. In the depicted arrangement there are two reinforced regions 32 diametrically opposite one another. The reinforcement may include carbon fibres, steel webbing or other cable or rope material integrated into the wall 34 to provide additional tensile strength. These are typically integrated into the wall during manufacture. The regions 32 maintain a tensile attachment of upper portions of the pole 30 to the base regions of the pole embedded in the ground.

The top of the pole 30 may include a top cap or plate. The reinforcement material 32 may extend over the plate to hold the plate in place.

In some arrangements the reinforced regions 32 are used in conjunction with the secondary energy-absorbing system of the die 18 and the compressible foam 16. The reinforcement 32 may also be used in poles without the secondary energy-absorbing system.

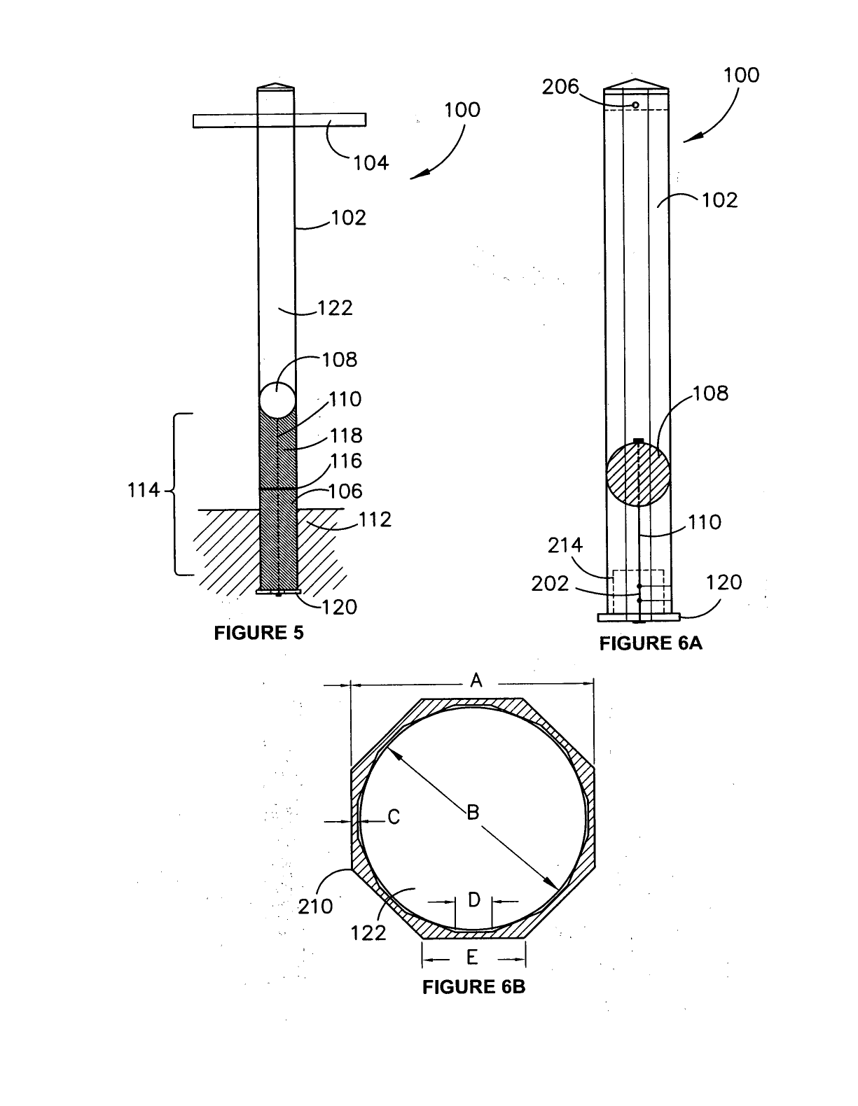

FIG. 5 illustrates another arrangement in which a utility pole is provided with a shear region 116 that can cause the pole to break away in the event of a collision.

The utility pole 100 includes an upper portion 102 with a cross arm 104 for attaching cables such as electricity cables (not shown), and a base section 106 that in use is embedded in the ground 112 or a similar support medium. The utility pole 100 is made of a lightweight composite material. The cross arm 104 may be formed from the same composite material as or a different material to the pole 100. In some applications the utility pole may not carry cables and may carry signs, lights, solar panels or other equipment.

A shear region 116 is formed at the interface between the upper portion 102 and the base section 106. The shear region 116 provides a weakened connection interface between the upper portion 102 and the base section 106 that is likely to be the line at which the pole 100 breaks away upon collision of a vehicle with the pole 100. The shear region 116 is positioned relatively low in relation to the vehicle, for example below the height of the bumper of a car.

The shear region should provide sufficient structural strength for the pole to perform its day-to day functions such as carrying cables or streetlights.

The shear region 116 may be implemented in a number of ways. For example, if the material forming the pole is a composite material, it may include a weakened area implemented through an increase in porosity of the material, or through a perforation through the material. Other methods known in the art may be used, such as attaching the upper portion 102 to the base section 106 using an adhesive material or other material that is adapted to fail when the utility pole 100 is subject to an impact, or any other attachment mechanism adapted to fail upon impact. Other ways of providing a shear region in the pole include varying the relative proportions and configuration of the reinforcing fibres and the matrix in the composite material.

Inside the upper portion 102 is a pole cavity 122. Inside the pole cavity 122 is a crushing or compression mechanism, shown in this embodiment as a sphere 108 although other shapes including the frusto-conical plunger of FIG. 3 may be used. The plunger 108 is connected to the base section 106 using a link 110 such as a metal cable, for example a stainless steel cable. The link 110 can be connected to the plunger 108 and to the base section 106 in any suitable manner, and in the embodiment shown the link 110 is attached to the foot 120 of the base section 106.

The area 114 between the plunger and the bottom of the base section is filled with a compressible or crushable material 118. The material 118 can be a foam, such as those listed above with reference to FIG. 3.

Referring to FIG. 6A, the foot 120 of the pole 100 includes a base plug 214 that assists in anchoring the cable 110 in the base section 106 and/or anchoring the base in the ground.

The base plug 214 and top cap 206 may be made of any suitable rigid material, for example steel.

Referring to FIG. 6B, the pole 100 may have any outer cross sectional shape suitable for a utility pole, such as a circle for a cylindrical pole, or the octagonal shape 210 as shown. The shape of the cross section of the pole cavity 122 is adapted to the shape of the plunger, and is shown to be substantially circular in this embodiment.

The dimensions of the pole 100 can vary, depending on the type of utility pole that is used. In the embodiment shown, referring to FIG. 6B the dimensions are as follows: A=260 mm, B=245 mm, C=7 mm, D=38 mm, E=107 mm.

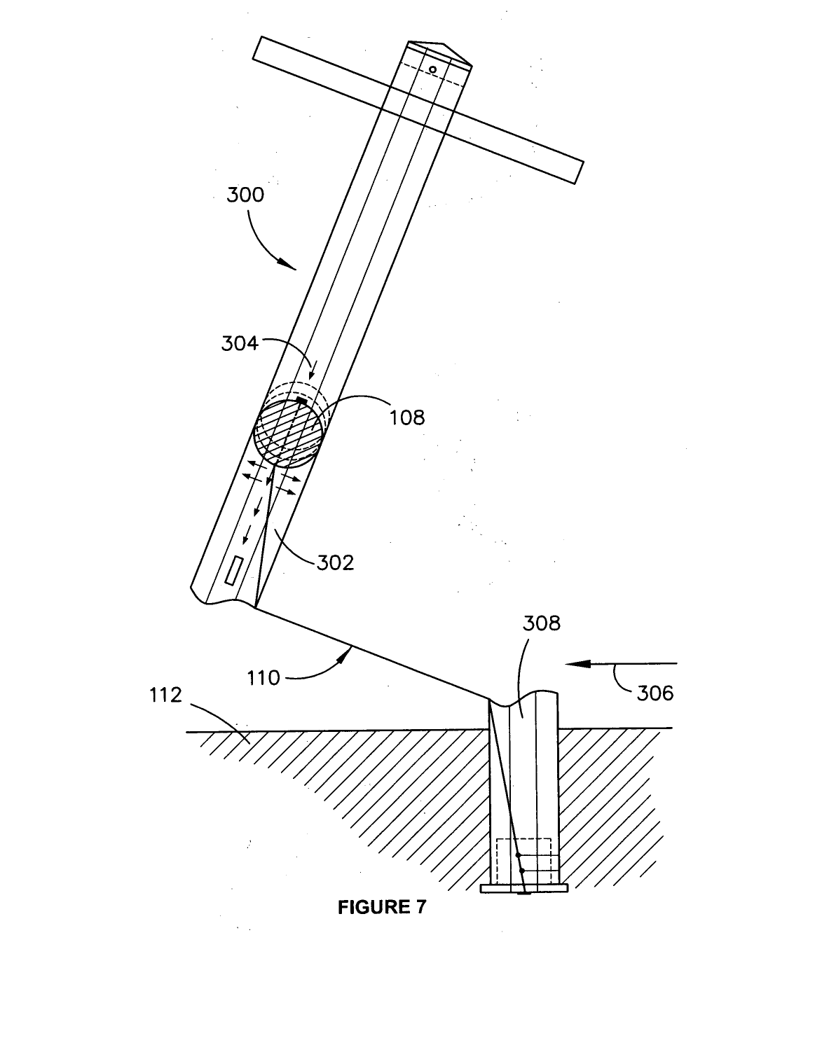

Referring to FIG. 7, impact with the utility pole 100 (the direction of impact shown by arrow 306) may result in break away of the upper portion 102 resulting in a severed pole 300. The severed pole 300 remains connected to the severed base 308 via the link 110.

As the lower end of the severed pole 300 moves away from the severed base 308 after break away, the link 110 draws the plunger 108 downwards, thereby compressing or crushing the material 118, which acts as a retarding means 302. Arrow 304 indicates the direction of movement of the plunger 108.

The severed base 308 may be sufficiently low to not obstruct or further damage the moving vehicle after impact. Furthermore, because the shear region 116 is low down on the pole 100, the action of the link 110 on the vehicle will also be relatively low down and this may minimise the damage on the vehicle caused by the link 110. For example, if a cable is used as a link 100, and a vehicle collides with the pole 100, the low shear region 116 will be below the height of the front bumper or buffer of the vehicle so that the action of the cable will be sufficiently low so that the cable will not cut through the vehicle, but rather will slow the vehicle down.

The link 110 together with the compressed or crushed material 302 acts to absorb the energy of the moving vehicle after impact so that the vehicle can slow down further after the impact. Apart from contributing to energy absorption by crushing the foam, the functions of the link 110 also include restricting the movement of the severed pole 300 (for example, limiting a pendulum action). As the vehicle is slowed down by the link 110 and the vehicle therefore exerts force on the link 110, this contributes to a further force being applied to the plunger 108 in order to increase the crushing or compression of the material 302. This in turn may further contribute to the energy absorption effects of the utility pole 100.

If the utility pole is used to suspend electrical cables from the cross arm 104, the load on the cables that would result in pulling the cables down and damaging or breaking them after break away may typically be in the order of 300 to 500 kg. With the light-weight composite material used for this utility pole, however, the weight of the severed pole 300 may be less than this load (for example, between 100 and 200 kg). The relatively low loading on the cables after break away together with the link cable 110 limiting the movement of the severed pole, limit the damage done to overhead cables due to a collision of a vehicle with the utility pole.

In further arrangements the cross arms supporting electric wires may be attached to a utility pole using a sleeve or similar breakaway structure. The purpose of the sleeve, or similar structure, is that as the base of the pole is distorted following impact by a vehicle, the top section of the pole structure including the cross arm and the electric cables disengages from the lower portion of the pole. This arrangement reduces the likelihood of damage to the electric cables and hence disruption of the power supply. The arrangement also makes it possible to easily replace the lower part of the utility pole, in an operation that does not require much labour and is less likely to disrupt the power supply.

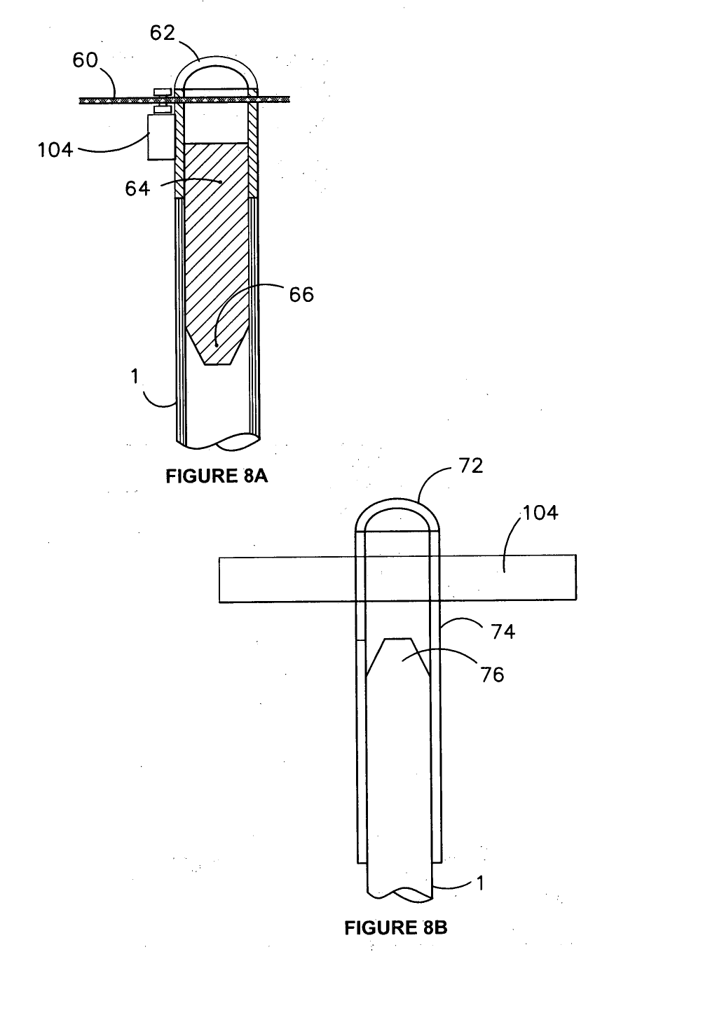

FIG. 8A illustrates a configuration in which the upper portion 64 is an inner sleeve that may be inserted into the main columnar portion of the utility pole 1. The upper portion 64 is attached to a cross arm 104 that may support electric cables 60. The upper portion 64 has a tapering lower end 66 that is configured to be received into the interior of the pole 1. The upper portion 64 may have a loop 62 that may be used to lift the upper portion when fitting a pole 1 and upper portion 64.

FIG. 8B shows another configuration in which the upper portion 74 is an outer sleeve that has a sliding fit over the top end of the pole 1. The pole 1 may have a tapered upper end 76 to make it easier to fit the upper portion 74 over the pole 1. The upper portion may be attached to the cross arm 104, and may have a loop 72 that may be used, for example by a crane, to manipulate the upper portion 74.

The length of the sleeve 64, 74 may assist in controlling the post-impact motion of the pole 1. An objective is to have the pole 1 acquire sufficient forward rotation so that the pole is less likely to rotate backwards after the pole 1 slips out of the sleeve 64, 74 and reach the roof of the vehicle.

The sleeve 64, 74 may be manufactured of a lighter material than the lower portion of the pole, since the sleeve may not require the same resistance to bending moments as the cantilevered in-ground base section of the pole.

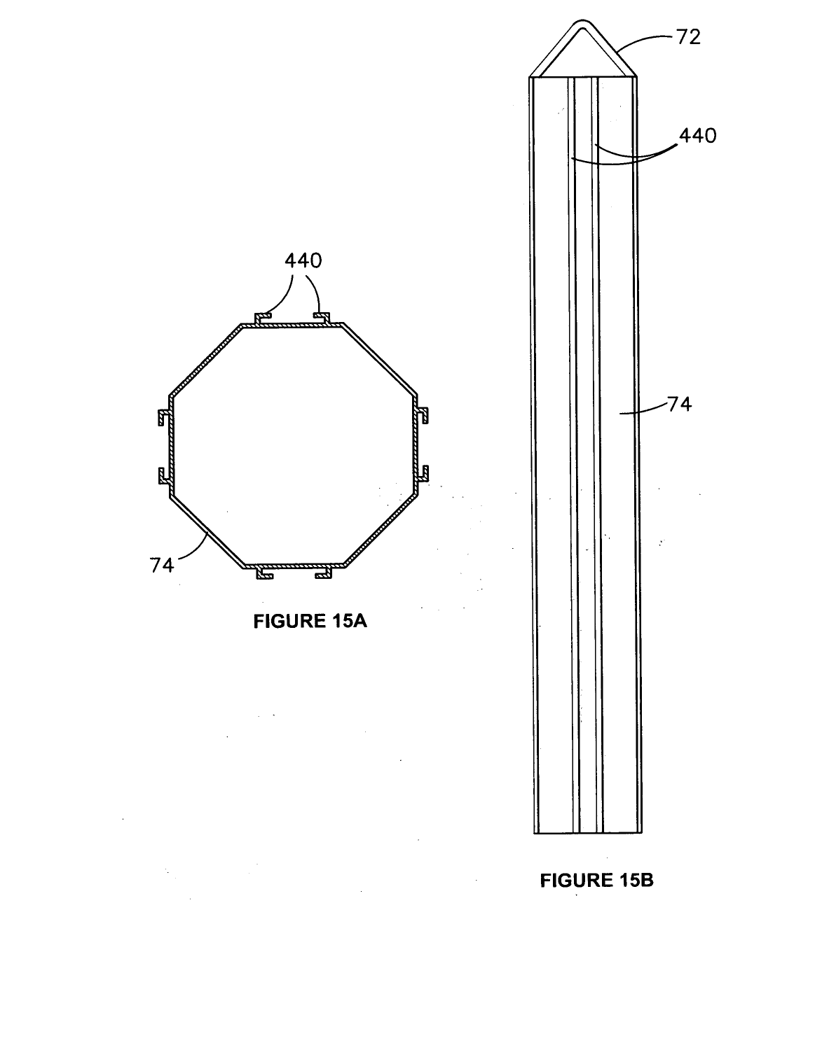

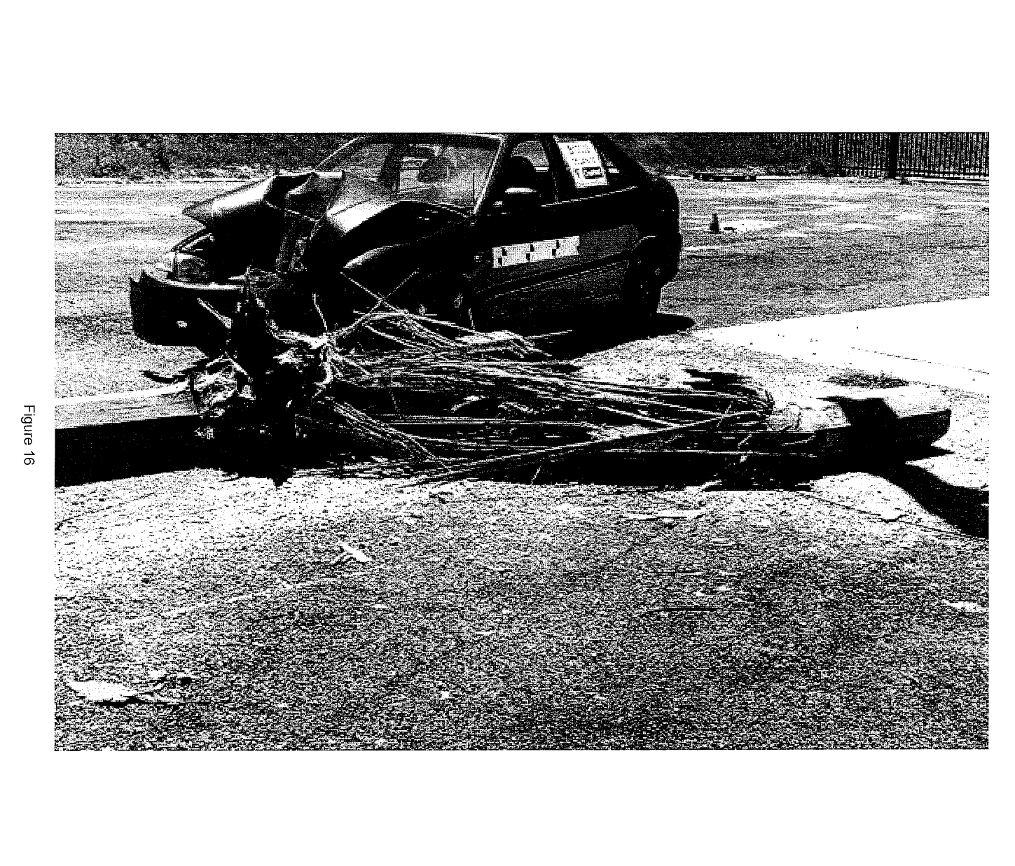

As shown in FIG. 15A and B, “C”-shaped channels or extrusions of other convenient shape may be provided on the sleeve 74 for use in mounting cross-arms, spars, light fittings etc, or supplementary cables such as fibre optic cables.

A typical timber utility pole has high-voltage electricity cables attached to its cross arms or spars. When the base of a timber pole is struck by a vehicle this can cause the pole to break either at the base, or sometimes at a higher weakened section of the pole. The weight of the timber pole is taken by the high voltage electricity cables. Often this larger weight causes the electricity cables to break and fall to the ground, where they create a potentially serious hazard for the vehicle occupants, other adjacent road users, or rescuers. The unrestrained timber pole is also a significant hazard.

The sleeve arrangements described herein reduce the loads on the electricity cables and the likelihood of the cables breaking and falling to the ground for a number of reasons, including:
the hollow section of the composite pole has a considerably lower mass per lineal metre compared to a traditional timber, steel or concrete pole;
only the top section of the composite pole assembly remains connected to the cross arms which support the electricity cables, thus reducing the potential load on the cables;
the overlapping sleeve between the top section of the pole and the main middle section of the pole controls the rate of rotation of the middle section of the pole, hence potentially reducing the tensile loads on the electricity cables;
the sleeve of the top section of the pole means that the top section may remain in contact with the mid-section of the pole after a collision and may hence prop up the electricity cables above ground level like a clothes prop (see FIG. 14);
alternatively, if the overlapping sleeve of the top portion separates from the mid-section of the pole, then a sleeve length of 3 or more metres should be sufficient to generally support the electricity cables above ground level, by an old-fashioned clothes prop style mechanism, so that the live electricity wires are above the level of the crashed vehicle or adjacent road users.

An overall effect is a lower likelihood of disruption to the power supply.

The intention of the arrangement is to maintain the electricity and communication cables etc. in relatively undamaged condition. A new mid-section of the pole may then slipped into the in-ground plug, and then the upper sleeve section 64, 74 of the pole may lifted up and slipped over the new mid section of the pole.

Timber power poles are typically secured in the ground by drilling a hole, inserting the timber pole and then packing earth firmly around the base of the pole. This is sometimes supplemented by concrete. The solid base is needed to support the pole and provide strength in the cantilevered mode in which fittings are attached to the top of the pole. The solid base also helps resist some of the transverse loads that arise from the attachment of electricity and other cables, and also wind forces.

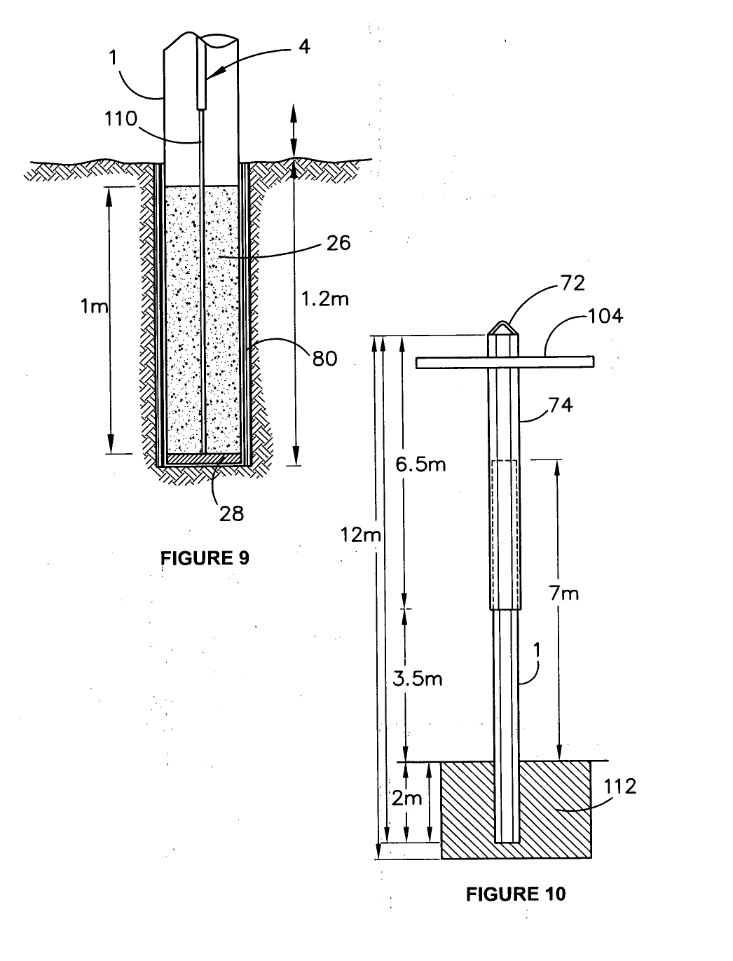

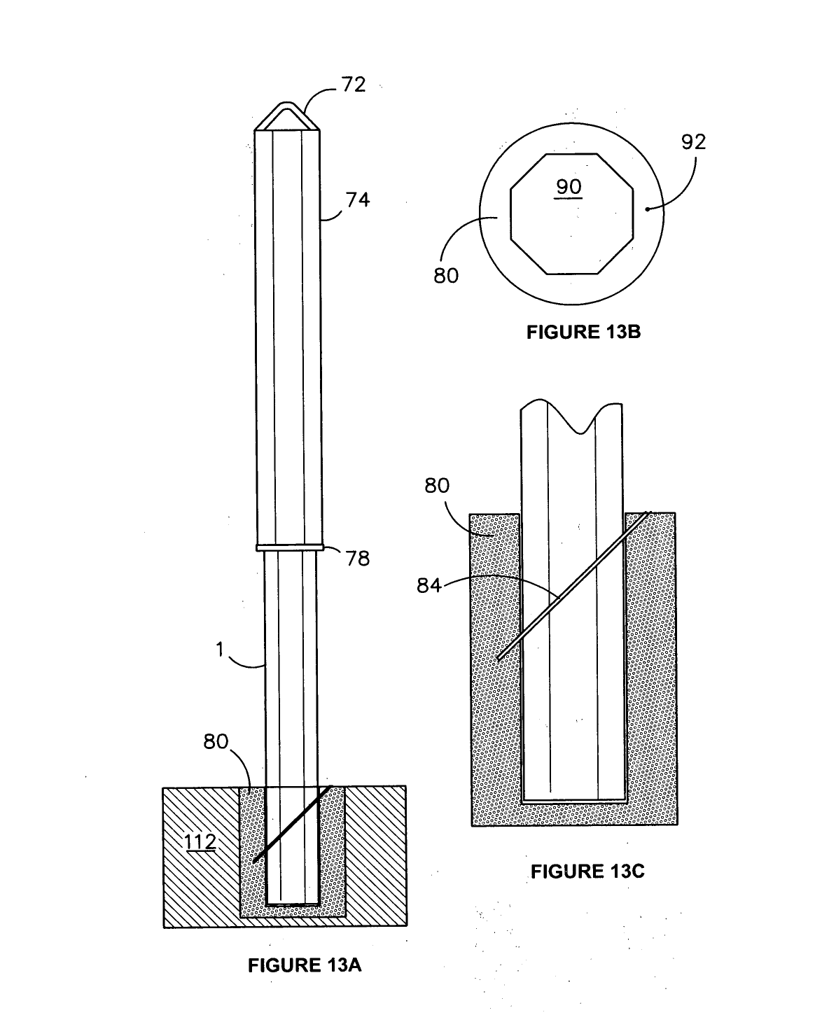

The poles described herein could also be mounted in this manner. However, an alternative is to use the arrangements of FIG. 9 or 13. In the arrangement of FIG. 9, a hole is drilled in the ground. A sleeve 80, which may be formed of composite material or concrete, is inserted into the hole. The sleeve is configured to provide a clearance fit with the utility pole 1. The sleeve 80 may be formed with the same diameter as the upper sleeve 74. The external sleeve 80 may be secured in the ground using conventional techniques such as packing earth or concreting.

In one arrangement the sleeve 80 is about 2 m long. To restrict the pole 1 from being pulled out of the ground, about 2 m of the interior of the pole above the base plate 28 may be filled with a high-density foam 26 or other low-compressibility material such as concrete. The dense material 26 helps to maintain the shape of the lower region of the pole 1 and helps retain the pole 1 like a peg in the sleeve 80.

Locking pins, dowels, wedges or the like may also be used to secure the base of the pole in the ground sleeve.

Permanently fixed in-ground sleeves 80 assist in the easy and economical replacement of the mid-section pole after permanent damage caused by impact. The damaged mid-section of the pole may be pulled out of the in-ground sleeve 80, and a new mid-section lowered into the sleeve 80. The top section of the pole may then be lifted, for example using a crane, and lowered over the newly-mounted mid-section. This may be done with minimal interruption to local power supplies.

FIG. 10 shows an example of dimensions of a utility pole assembly that includes pole 1, upper sleeve 74 and cross arm 104 attached to the upper sleeve 74. The pole 1 and sleeve 74 may be manufactured with pultruded fibre-reinforced polymers (FRPs). Here, a total length of the pole assembly is around 12 m. The length of pole 1 is about 9 m. In use, about 2 m of pole 1 is embedded in the ground 112. The length of the upper sleeve 74 is about 6.5 m and in use the lowest end of the sleeve 74 is positioned about 3.5 m above the ground 112. Other dimensions may be used in different applications.

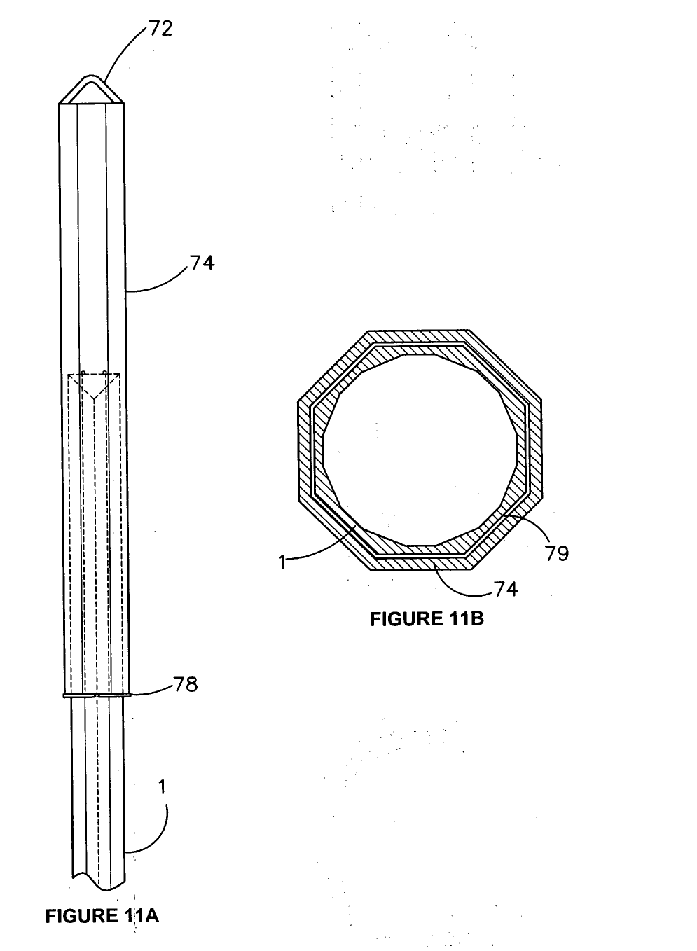

FIG. 11A shows a further view of the pole and sleeve 74. A sleeve stop 78 is provided on the pole 1 to position the sleeve 74 when assembled. FIG. 11 B shows a cross section of the assembly, illustrating the slip joint 79 between the pole 1 and the sleeve 74.

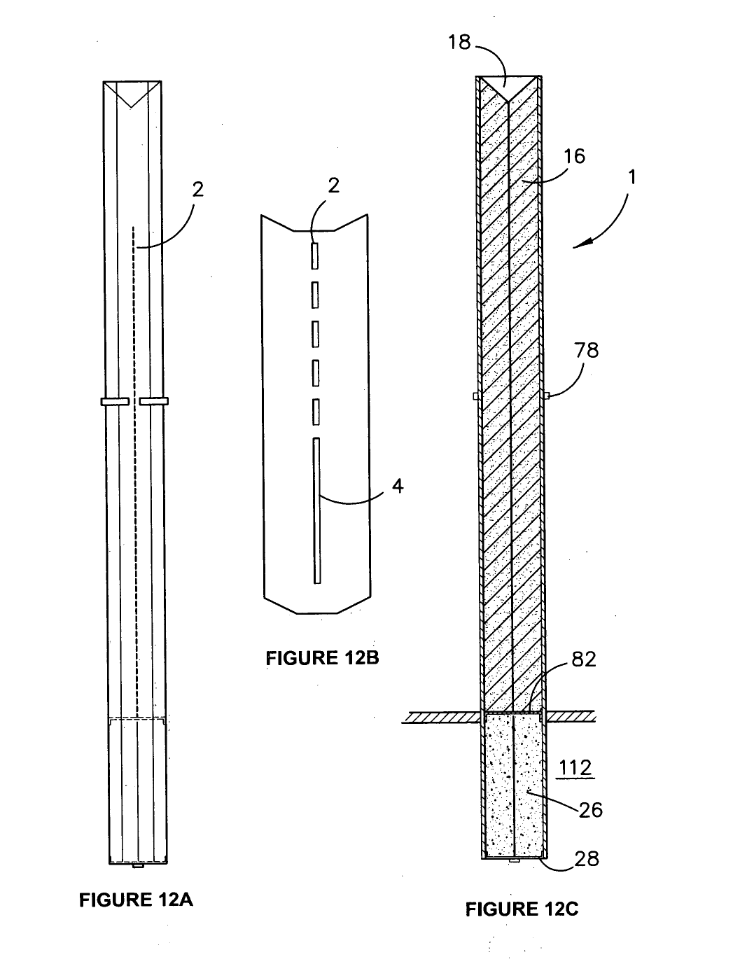

An embodiment of the pole 1 is shown in FIGS. 12A to 12C. The top plate of the pole 1 is a plunger 18 which is linked to the base plate 28 of the pole 1 by the central cable 14. A separation plate 82 may be provided about 2 m from the base plate 28. Above the separation plate the pole 1 may be filled with compressible foam 16. Below the separation plate, the pole may be filled with a relatively incompressible foam 26. Slots 2, 4 provide a region of controlled delamination in the event of impact.

FIG. 13 shows the assembly 1, 74 mounted in an in-ground sleeve 80 made of concrete. The sleeve 80 has an inner cross-sectional area 90 configured to accommodate the pole 1, as seen in FIG. 13B. A hole 92 may be provided that runs through the sleeve 80 to accommodate a tie rod 84. A corresponding hole is formed in the base of the pole 1. The pole is mounted in the sleeve 80 such that the hole 92 lines up with the hole in the pole 1, enabling the tie rod to be installed. This arrangement helps ensure that the base of the pole 1 is not pulled out of the ground 112 if the pole is struck. This assists in bringing the colliding vehicle to a halt.

Upon impact on the base of the pole from the leading side of the vehicle, the weakened sections of the walls of the struck area of the pole commence to delaminate and the adjacent foam crushes.

The deliberate weakening of the section of the pole likely to be directly impacted by a impacting vehicle is designed to facilitate the process of delamination of the composite materials of the wall of the pole. As the walls delaminate, they lose their vertical stiffness and strength. The walls deform away from the impacting face of the vehicle, while the fibre/cloth part of the composite material is intended to keep the base of the pole connected to the in-ground part of the pole by the tensile strength of its fibres/cloth.

Once the process of delamination has been initiated by the weaker section of the base of the pole, the ongoing process of delamination is assisted by vertically extended weakening of the wall of the pole (by intermittent slots or other wall weakening mechanisms in manufacture).

This weakening of the pole wall extends up to a height of the desired ‘ride down’ distance of the pole. A ‘ride down’ distance of up to 6 metres, or possibly more, means that the impacting vehicle can be brought to a stop at a distance up to 6 metres, or possibly more, with the energy absorption of the deceleration distributed over that distance.

The weakening of the lower few metres of the base of the pole by the reduced wall thickness, changes in the bonding resin material and cloth mixture, or slots, will lead to some reduced stiffness/strength of the pole in cantilever mode. This is partly compensated for by filling this base section of the pole with foam, or other materials, which resists buckling and restores stiffness to the cylindrical pole section.

FIG. 14 schematically illustrates a pole assembly after a collision, indicated by arrow 306. The base section remains in the in-ground sleeve 80. A portion 404 of the mid-section pole 1 has delaminated as a result of the energy imparted by the impact. The extent of the delaminated regions is largely determined by the length weakening slots or notches provided in the pole 1. The pole 1 has been pulled down the sleeve 74, but has not been pulled entirely out of the sleeve 74. Before the collision the sleeve rested on sleeve step 78. The top plate of pole 1 has moved from an original location 400 to a final location 402 near the base of sleeve 74.

The cables 60 supported on cross arm 104 have been pulled downward, but are still essentially in position, supported by sleeve 74 and the upper part of pole 1 that has not delaminated. Even if the pole 1 is pulled entirely out of the sleeve 74, the sleeve 74 may still provide a support to hold the cables 60 off the ground 112.

In tests conducted on prototype poles the composite material started to yield when struck by a light car travelling at a controlled speed of 50 km/hr. The prototype poles were able to bring a light car to a stop from 80 km/hr within approximately 3 m, with complete preservation of the occupant space. The tested poles have been found to bring a light car to a stop from 100 km/hr in approximately 4 to 5 m with good preservation of the occupant space.

FIG. 16 is a photograph showing a pole after a collision with a vehicle travelling at 80 km/hr. The base of the pole remained in the ground during the collision, but has been removed for the photographs to be taken. The region of controlled delamination is clearly visible.

In some arrangements a sensor may be mounted on the utility pole to detect when a major impact has occurred. The sensor may be any suitable mechanical, electrical or other displacement or movement sensor. An output of the sensor may trigger an electronic signal generator which may, for example, send a data signal superimposed on the signal transmitted on the power or communication cables 60. The content of the data signal includes an alert indicating that a collision has occurred and an identifier to specify which pole has been affected.

Such an arrangement enables a rapid assessment of damage to the pole, and this may reduce or eliminate disruptions to power transmission or communications via cables 60.

Early notification of an impact increases the chances of identifying the colliding vehicle. This may assist in recovering the cost of pole repair. Early notification may also be beneficial in alerting emergency services such as ambulances to a collision.

It will be understood that the invention disclosed and defined in this specification extends to all alternative combinations of two or more of the individual features mentioned or evident from the text or drawings. All of these different combinations constitute various alternative aspects of the invention.

1. A utility pole comprising:
a hollow elongate body formed from a composite material including reinforcing fibres embedded in a matrix material; and
an energy-absorbing region comprising at least one weakened zone formed in the hollow elongate body, the at least one weakened zone promoting delamination of the fibres and the matrix material if a vehicle strikes the utility pole.

2. A utility pole as claimed in claim 1 wherein the weakened zone comprises a series of slots through the hollow body.

3. A utility pole as claimed in claim 2 wherein the series of slots comprises a first slot at an operatively lower end of the energy-absorbing region and a plurality of second slots that are co-linear with the first slot, wherein the second slots are shorter than the first slot.

4. A utility pole as claimed in claim 3 wherein the first slot has a length of around 60 cm, the second slots have a length of around 10 cm, and the first and second slots have a width of around 0.6-0.8 cm.

5. A utility pole as claimed in claim 1 wherein the weakened zone comprises a notch in the hollow body extending along the energy-absorbing region.

6. A utility pole as claimed in claim 1 comprising a first weakened zone and a second weakened zone located diametrically opposite the first weakened zone and wherein in use the utility pole is positioned such that an axis joining the first and second weakened zones is approximately ninety degrees to an anticipated direction of impact of the vehicle.

7. A utility pole as claimed in claim 1 comprising a base region that in use is mounted in the ground or other supporting medium, wherein the energy-absorbing region is provided above the base region such that in use the energy-absorbing region is above the ground or supporting medium.

8. A utility pole as claimed in claim 7 wherein the energy-absorbing region has a length of around 6 m.

9. A utility pole as claimed in claim 1 comprising:
compressible or crushable material provided within the hollow body in at least the energy-absorbing region.

10. A utility pole as claimed in claim 9 comprising:
a plunger located within the hollow body above the compressible or crushable material; and
a link connecting the plunger to a base of the pole wherein, if the link is laterally displaced during a collision of the vehicle and the pole, the link pulls the plunger through the compressible or crushable material thereby absorbing energy from the collision and retarding motion of the vehicle.

11. A utility pole as claimed in claim 10 wherein the plunger has a cross-sectional area that decreases towards the base of the pole.

12. A utility pole as claimed in claim 9 wherein the compressible or crushable material is a foam.

13. A utility pole as claimed in claim 9 comprising
filler material within the hollow body in the base region, the filler material being less compressible than the compressible or crushable material in the energy-absorbing region.

14. A utility pole assembly comprising:
a hollow elongate body formed from a composite material and having a base region that in use is mounted in the ground or other supporting medium and an energy-absorbing region comprising at least one weakened zone formed in the hollow elongate body, the at least one weakened zone promoting delamination of the composite material if a vehicle strikes the utility pole; and
a top section that in use is positioned above the hollow elongate body to provide a columnar pole assembly.

15. A utility pole assembly as claimed in claim 14 wherein the hollow elongate body is formed from a composite material including reinforcing fibres embedded in a matrix material.

16. A utility pole assembly as claimed in claim 14 wherein the top section has an engaging lower end that fits into an interior of the hollow elongate body.

17. A utility pole assembly as claimed in claim 14 wherein the top section comprises a sleeve that fits over an upper portion of the hollow elongate body.

18. A utility pole assembly as claimed in claim 17 wherein an exterior of the hollow elongate body has a projecting annular flange to assist in positioning the top section over the elongate body.

19. A utility pole assembly as claimed in claim 14 wherein the top section comprises one or more cross arms.

20. A utility pole assembly as claimed in claim 19 wherein the cross arms support at least one of: power cables, communication cables, light fittings and signs.

21. A utility pole assembly as claimed in claim 14 wherein the top section is formed of a material that is lighter than the composite material of the elongate body.

22. A utility pole assembly as claimed in claim 17 wherein the sleeve is configured to have a slip fit with the hollow elongate pole.

23. A utility pole assembly as claimed in claim 14 wherein the top section further comprises:
a sensor to detect at least one of displacement or movement of the top section; and
a signal generator to convey a signal indicative of a collision affecting the pole assembly.

24. A utility pole assembly as claimed in claim 23 wherein the signal includes data identifying the utility pole assembly.

25. A utility pole assembly as claimed in claim 14 further comprising:
an in-ground sleeve that in use is embedded in the ground or other supporting medium and having an inner volume shaped to accommodate and support the hollow elongate body.

26. A utility pole assembly as claimed in claim 25 wherein the in-ground sleeve and the hollow elongate body each comprise holes that in use line up to accommodate a tie rod passing though the body and in-ground sleeve to assist in retaining the body in the in-ground sleeve.

27. (canceled)
